(19) United States
(12) Patent Application Publication
(10) Pub. No.: US 2025/0207552 A1
(43) Pub. Date: Jun. 26, 2025

(54) ENGINE COMBUSTION CONTROL SYSTEM

(71) Applicant: Mazda Motor Corporation, Aki-gun (JP)

(72) Inventors: Tatsuya Tanaka, Aki-gun (JP); Yoshihisa Nakamoto, Aki-gun (JP); Kiyotaka Sato, Aki-gun (JP)

(21) Appl. No.: 18/950,441

(22) Filed: Nov. 18, 2024

(30) Foreign Application Priority Data
Dec. 20, 2023 (JP) 2023-215190

(51) Int. Cl. F02P 9/00; F02P 3/02; F02P 5/04

(52) U.S. Cl. CPC F02P 9/007; F02P 3/02; F02P 5/045

(57) ABSTRACT

An engine combustion control system includes an ignition coil, an igniter which induces high voltage in the ignition coil to cause electric discharge between plug electrodes of an engine spark plug, a bias voltage generator which applies bias voltage to the plug electrodes, an ion current detector, an ignition controller which controls the bias voltage to be applied simultaneously to a start of a low-temperature oxidation reaction, and the electric discharge occurs at an ignition timing later than the reaction start, and an estimator which estimates a fuel property based on an ion current detected during a period from the bias voltage application start to a given timing earlier than the ignition timing. The ignition controller corrects the ignition timing according to the fuel property in the same cycle as that of the fuel property estimation, and controls so that the electric discharge occurs at the corrected ignition timing.

### TECHNICAL FIELD

The present disclosure relates to a combustion control system which is applied to an engine provided with a cylinder and a spark plug which ignites a mixture gas inside the cylinder.

### BACKGROUND OF THE DISCLOSURE

A combustion control device of an engine as disclosed in JP5888773B2 is known. The combustion control system of JP5888773B2 includes an ignition coil having a primary coil and a secondary coil, a switching element which controls electric current to the primary coil, a spark plug which discharges electricity in response to induction voltage from the secondary coil, an ion signal detection circuit which detects ion current which flows between plug electrodes of the spark plug, and an ECU electrically connected to the switching element and the ion signal detection circuit. When an ignition timing arrives and the electricity-conducting period to the primary coil ends, the ECU calculates an accumulated value of the ion current from the electricity-conducting start to the primary coil, and determines whether a preignition occurred based on the calculated accumulated value.

When the occurrence of the preignition is determined, the combustion control system of JP5888773B2 executes a suitable control for suppressing the preignition. However, since the preignition is determined based on the accumulated value of the ion current detected during the period from the electricity-conducting start to the primary coil to the electricity-conducting end (in other words, the ignition timing), ignition has already ended when the preignition is determined, and therefore, combustion is considered to be advanced considerably at this point. Thus, there is a problem in which the substantial suppressing control of the preignition cannot be executed until at least the next cycle. Further, in order to avoid such a problem arising, the engine may be designed on the safer side so as to avoid abnormal combustion like the preignition as much as possible. However, this may lower thermal efficiency of the engine.

### SUMMARY OF THE DISCLOSURE

Therefore, the present disclosure is made in view of the above problems, and it aims at providing a combustion control system of an engine, capable of suppressing an occurrence of abnormal combustion in advance, while improving thermal efficiency of the engine.

In order to solve the above problem, the present disclosure provides a combustion control system to be applied to an engine provided with a cylinder, an injector configured to inject fuel into the cylinder, and a spark plug configured to ignite a mixture gas containing the fuel injected from the injector, which includes an ignition coil including a primary coil and a secondary coil, an igniter which induces high voltage in the secondary coil through ON/OFF of supply of electric current to the primary coil, and causes electric discharge between plug electrodes of the spark plug by the induced high voltage, a bias voltage generator which applies bias voltage for detecting ion current to the plug electrodes, the ion current occurring between the plug electrodes and originating in ions inside the cylinder, an ion current detector which detects the ion current, an ignition controller which controls the bias voltage generator to apply the bias voltage to the plug electrodes at a same timing as a start of a low-temperature oxidation reaction caused inside the cylinder with compression of the mixture gas, and controls the igniter to cause the electric discharge between the plug electrodes at an ignition timing set to a timing later than the start of the low-temperature oxidation reaction, and a processor which estimates a property of the fuel injected from the injector based on the ion current detected by the ion current detector during a detection period from a timing at which the application of the bias voltage is started to a given timing earlier than the ignition timing. The ignition controller corrects the ignition timing according to the property of the fuel, in the same cycle as that when the property of the fuel is estimated, and controls the igniter to perform the electric discharge at the corrected ignition timing.

According to the present disclosure, since the property of the fuel (hereinafter, also referred to as “the fuel property”) is estimated based on the ion current detected before the ignition timing, and the ignition timing is corrected according to the estimated fuel property, the ignition timing can be adjusted to a suitable timing in consideration of a difference in the fuel property. In other words, since the difference in the fuel property influences a risk of knocking, according to the present disclosure in which the ignition timing is corrected based on the fuel property, mixture gas can be ignited at the ignition timing at which the thermal efficiency is as high as possible, within a range where knocking does not occur. In addition, since the fuel property is estimated before the ignition timing, the ignition timing in the same cycle as that when the estimation is performed can be adjusted in advance to the suitable timing in consideration of knocking. Therefore, knocking can be prevented in advance, while improving the thermal efficiency.

The processor may estimate a ratio of isooctane contained in the fuel as the property of the fuel. The ignition controller may correct the ignition timing toward a retarding side as the ratio of isooctane decreases.

The ratio of isooctane contained in the fuel (hereinafter, also referred to as “the isooctane ratio”) is one of the typical fuel properties which influence on the risk of knocking. In detail, a large isooctane ratio means that knocking cannot easily occur, and a small isooctane ratio means that knocking can easily occur. Therefore, according to the present disclosure in which the ignition timing is corrected toward the retarding side as the isooctane ratio decreases, knocking due to the fuel property can be suppressed effectively. Conversely, when the isooctane ratio is large, the ignition timing is set toward the advancing side. Therefore, the thermal efficiency can be improved while suppressing knocking.

The processor may calculate an ion current feature quantity correlating with the property of the fuel, based on the ion current detected during the detection period, and estimate the ratio of isooctane from the calculated ion current feature quantity.

According to this configuration, since the ion current feature quantity correlating with the isooctane ratio is calculated based on the ion current detected during the detection period, the isooctane ratio can be estimated appropriately from the ion current feature quantity.

The ion current feature quantity may be a maximum charge amount that is a maximum value of a charge amount between the plug electrodes during the detection period, and the processor may estimate the ratio of isooctane to be larger as the maximum charge amount decreases.

According to this configuration, the isooctane ratio can be estimated appropriately based on the maximum charge amount, by using the finding that the isooctane ratio increases as the maximum charge amount decreases.

The ion current feature quantity may be a maximum ion current that is a maximum value of the ion current during the detection period. In this case, the processor may estimate the ratio of isooctane to be larger as the maximum ion current decreases.

Also according to this configuration, the isooctane ratio can be estimated appropriately.

The ignition controller may control the bias voltage generator so that the bias voltage increases gradually from the start of the low-temperature oxidation reaction and decreases gradually thereafter.

When the bias voltage is changed in a bell-shaped curve in this way, the charge amount between the plug electrodes can be changed in a similar bell-shaped curve. This makes it easier to calculate the above-described maximum charge amount which is the maximum value of the charge amount, or the above-described maximum ion current which is the maximum value of the ion current. Further, since the ion current which increases with the start of the low-temperature oxidation reaction is further amplified by the gradual increase of the bias voltage, sensitivity of the maximum charge amount or the maximum ion current which changes with the difference of the isooctane ratio can be improved. Therefore, the estimation precision of the isooctane ratio can be improved.

The bias voltage generator may be a capacitor device connected to the secondary coil.

According to this configuration, the bias voltage can be controlled appropriately by adjusting the charge amount of the capacitor device.

The ignition controller may control the bias voltage generator so that the application start of the bias voltage is advanced as an engine speed increases.

Alternatively, the ignition controller may control the bias voltage generator so that the application start of the bias voltage is advanced as an engine load increases.

According to this configuration, the bias voltage can be applied at the same timing as the start of the low-temperature oxidation reaction which is advanced as the engine load or the engine speed increases, and the ion current which increases with the start of the low-temperature oxidation reaction can be detected appropriately.

The combustion control system may further include an abnormal combustion determinator which determines an occurrence of a preignition based on the ion current detected by the ion current detector, and an injection controller which causes the injector to inject additional fuel when the occurrence of the preignition is determined.

According to this configuration, since a latent heat of vaporization of the additionally-injected fuel lowers an internal temperature of the cylinder, the progress of combustion of mixture gas can be slowed down to reduce the influence of the preignition.

### BRIEF DESCRIPTION OF DRAWINGS

FIG. 1 is a system chart illustrating the overall configuration of an engine to which a combustion control system according to one embodiment of the present disclosure is applied.

FIG. 2 is a view of a spark plug, where a tip-end part thereof is enlarged.

FIG. 3 is a circuit diagram illustrating a configuration of an ignition circuit.

FIG. 4 is a view corresponding to FIG. 3, illustrating a flow of discharge current.

FIG. 5 is a view corresponding to FIG. 3, illustrating a flow of ion current.

FIG. 6 is a graph illustrating a waveform of bias voltage applied to plug electrodes, together with a charge signal.

FIG. 7 is a graph illustrating a change in a charge amount between the plug electrodes in conditions with different isooctane ratios of fuel.

FIG. 8 is a graph illustrating a relationship between the isooctane ratio and the maximum charge amount.

FIG. 9 is a flowchart illustrating the first half of a combustion control executed while the engine operates.

FIG. 10 is flowchart illustrating the second half of the combustion control.

FIG. 11A is a graph illustrating a relationship between an engine load and a start timing of a low-temperature oxidation reaction.

FIG. 11B is a graph illustrating a relationship between an engine speed and the start timing of the low-temperature oxidation reaction.

FIG. 12 is a graph illustrating a relationship between the isooctane ratio and a corrected ignition timing.

### DETAILED DESCRIPTION OF THE DISCLOSURE

### (1) Overall Configuration of Engine

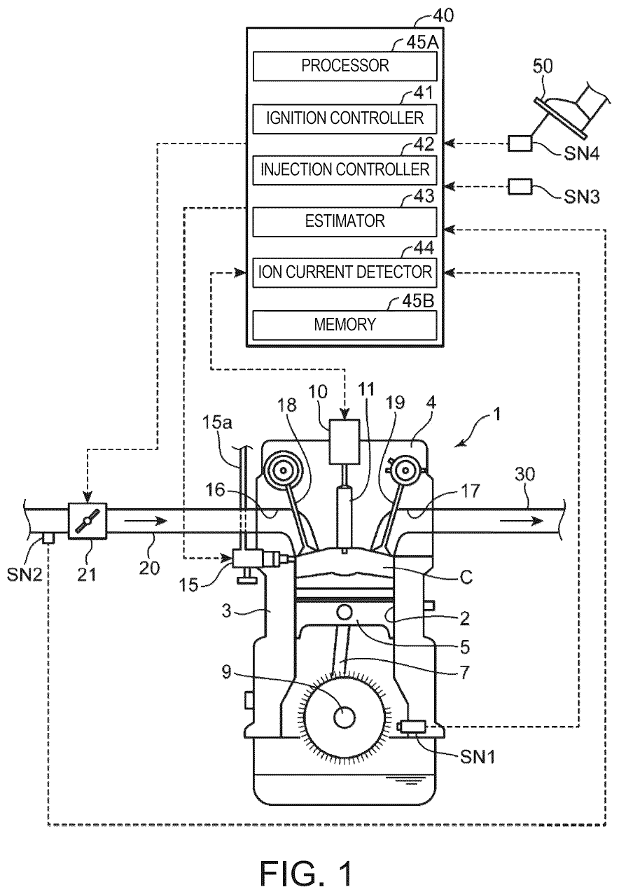

FIG. 1 is a system chart illustrating the entire configuration of an engine to which a combustion control system according to one embodiment of the present disclosure is applied. The engine illustrated in this figure is a spark-ignition four-cycle engine mounted on a vehicle as a power source for propelling the vehicle. The engine includes the engine (engine 1), an intake passage 20 and an exhaust passage 30 connected to the engine 1, and an ECU 40 which controls each part of the engine 1. Note that, although in this embodiment “up” and “down” are defined on the basis of FIG. 1, this is for facilitating the following explanation and does not intend to limit the installation posture of the engine 1.

The engine 1 includes a cylinder block 3 and a cylinder head 4 which define a cylinder 2 therein, and a piston 5 which is reciprocatably accommodated in the cylinder 2. A combustion chamber C is formed above the piston 5. Note that, although only one cylinder 2 is illustrated in FIG. 1, the engine 1 may be a multiple-cylinder engine having a plurality of cylinders 2.

An ignition circuit 10, a spark plug 11, and an injector 15 are attached to the cylinder head 4. The injector 15 is an injection valve which injects into the combustion chamber C fuel (e.g., gasoline) supplied from a fuel tank (not illustrated) through a fuel feeding pipe 15a. The spark plug 11 is a plug which ignites mixture gas generated by mixing the fuel injected into the combustion chamber C from the injector 15 with air. The ignition circuit 10 is a circuit which applies high voltage for making the spark plug 11 generate sparks for ignition. When the mixture gas inside the combustion chamber C combusts, triggered by the ignition of the spark plug 11, the piston 5 reciprocates in response to expansive force due to the combustion.

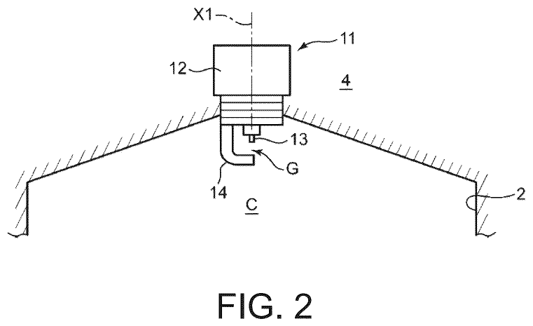

FIG. 2 is a view illustrating the spark plug 11, where a tip-end part thereof is enlarged. As illustrated in this figure, the spark plug 11 includes a plug body 12, a center electrode 13, and an earth electrode 14. The plug body 12 has a cylindrical shape extending along a cylinder axis X1 which is the center axis of the cylinder 2, and is attached to the cylinder head 4 in a state where the tip-end part is exposed to the inside of the combustion chamber C. The center electrode 13 projects downwardly from the center of the tip-end part of the plug body 12. The earth electrode 14 extends downwardly and is bent in an L-shape at a location near the tip-end part of the plug body 12. The tip end of the earth electrode 14 opposes to the center electrode 13 with a given gap G therebetween.

The center electrode 13 is connected to a secondary coil 103 (described later) of the ignition circuit 10. The earth electrode 14 is connected to the ground via the plug body 12 and the cylinder head 4. When performing ignition, electric discharge is performed between the center electrode 13 and the earth electrode 14 by applying the high voltage to the center electrode 13 from the ignition circuit 10. Thus, mixture gas is ignited by sparks generated by this electric discharge. Note that, below, the center electrode 13 and the earth electrode 14 may be comprehensively referred to as “the plug electrodes 13 and 14.”

As illustrated in FIG. 1, a crankshaft 9 which is an output shaft of the engine 1 is disposed below the piston 5. The crankshaft 9 is rotatably supported by the cylinder block 3. The above-described reciprocating motion of the piston 5 is transmitted to the crankshaft 9 via a crank mechanism including a connecting rod 7 to rotate the crankshaft 9.

A crank angle sensor SN1 is attached to the cylinder block 3. The crank angle sensor SN1 is a sensor for detecting a crank angle which is a turning angle of the crankshaft 9, and an engine speed which is a rotational speed of the crankshaft 9.

An intake port 16 and an exhaust port 17 are formed in the cylinder head 4. The intake port 16 is a port which communicates the combustion chamber C with the intake passage 20. The exhaust port 17 is a port which communicates the combustion chamber C with the exhaust passage 30. An intake valve 18 and an exhaust valve 19 which are interlocked with the rotation of the crankshaft 9 to open and close the intake port 16 and the exhaust port 17, respectively, are attached to the cylinder head 4.

The intake passage 20 is connected to one side surface of the cylinder head 4 to communicate with the intake port 16. A throttle valve 21 which opens and closes to adjust a flow rate of intake air is provided to the intake passage 20. An air flow sensor SN2 which detects a flow rate of the intake air is provided at a position of the intake passage 20 upstream of the throttle valve 21.

The exhaust passage 30 is connected to the other side surface of the cylinder head 4 to communicate with the exhaust port 17. A catalyst which removes hazardous components in exhaust gas (not illustrated) is provided to the exhaust passage 30.

An ECU 40 is a controller which mainly includes a microcomputer having a processor 45A (e.g., Central Processing Unit (CPU)) which performs various calculations, a memory 45B, such as a Read-Only Memory (ROM) and a Random Access Memory (RAM), and various kinds of input/output buses. The ECU 40 accepts input information from sensors provided to the engine 1. For example, the ECU 40 is electrically connected to the crank angle sensor SN1 and the air flow sensor SN2. Information on the detection by the sensors SN1 and SN2 (i.e., the crank angle, the engine speed, and the intake air flow rate) is sequentially inputted into the ECU 40.

The ECU 40 also accepts input information from sensors provided to the vehicle. For example, the ECU 40 is electrically connected to a vehicle speed sensor SN3 and an accelerator sensor SN4 which are provided to the vehicle. The vehicle speed sensor SN3 is a sensor which detects a traveling speed of the vehicle (i.e., a vehicle speed), and the accelerator sensor SN4 is a sensor which detects an opening of an accelerator pedal 50 operated by a vehicle driver who operates the vehicle (i.e., an accelerator opening). The detection information of the sensors SN3 and SN4 (the vehicle speed and the accelerator opening) is sequentially inputted into the ECU 40.

The ECU 40 controls each part of the engine by performing various calculations and determinations based on the input information from the sensors SN1-SN4. For example, the ECU 40 is electrically connected to the ignition circuit 10 and the injector 15, and suitably outputs a signal for controlling to each of them.

As for functional elements related to the control, the ECU 40 has an ignition controller 41, an injection controller 42, an estimator 43, and an ion current detector 44. The ignition controller 41 is a software module which controls ignition operation of the spark plug 11 through an electrical power control to the ignition circuit 10. The injection controller 42 is a software module which controls injection operation of the injector 15. The estimator 43 is a software control module which performs various calculations and determinations necessary for determining the contents of control by the ignition controller 41 and the injection controller 42. The ion current detector 44 is a software module which detects ion current which is created between the plug electrodes 13 and 14 of the spark plug 11 based on the signal from the ignition circuit 10. The memory 45B is a storage device which stores various data necessary for the control or the calculation. The various software modules are stored in the memory 45B and executed by the processor 45A to perform their respective functions.

### (2) Configuration of Ignition Circuit

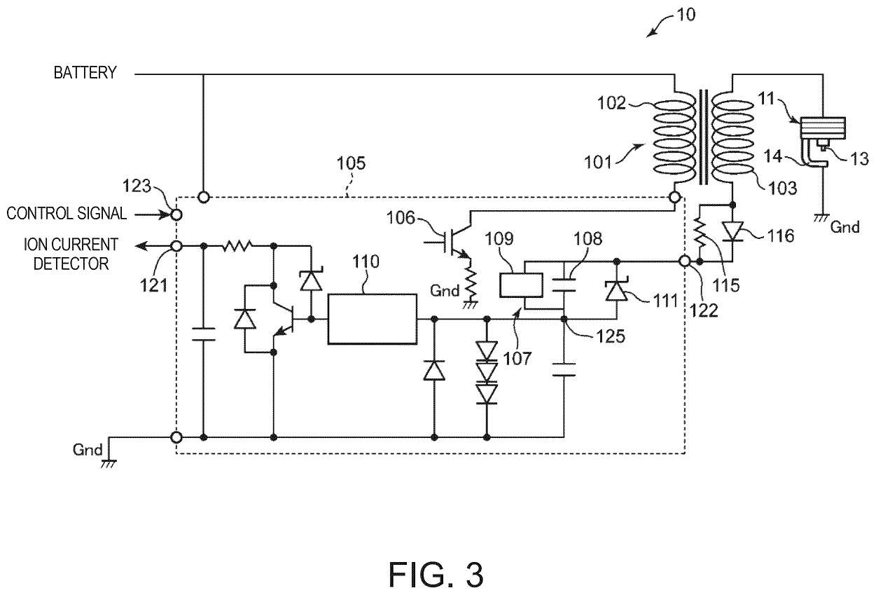

FIG. 3 is a circuit diagram illustrating a configuration of the ignition circuit 10. As illustrated in this figure, the ignition circuit 10 includes an ignition coil 101 which applies high voltage for electric discharge to the spark plug 11, and a coil driver 105 which realizes ON/OFF operation of electric current to the ignition coil 101.

The ignition coil 101 includes a primary coil 102 connected to a battery (not illustrated), and a secondary coil 103 connected to the center electrode 13 of the spark plug 11. The primary coil 102 and the secondary coil 103 are wound around a common core (iron core).

The coil driver 105 includes an igniter 106, a capacitor device 107, a current amplifier circuit 110, and a Zener diode 111. The igniter 106 is a transistor interposed between the primary coil 102 and the ground (Gnd), and a collector is connected to the primary coil 102 and an emitter is connected to the ground. The capacitor device 107 is interposed between the secondary coil 103 and the ground. The Zener diode 111 is electrically connected in parallel with the capacitor device 107. The current amplifier circuit 110 is interposed between a terminal 121 connected to the ion current detector 44 of the ECU 40, and an negative-polarity-side terminal 125 of the capacitor device 107.

Between the secondary coil 103 and the coil driver 105, a resistance 115 and a diode 116 which are connected in parallel to each other are provided. That is, the secondary coil 103 is connected to a terminal 122 of the coil driver 105 via the resistance 115 or the diode 116.

The igniter 106 induces high voltage in the secondary coil 103 through ON/OFF of the electric current to the primary coil 102, and the induced high voltage causes electric discharge between the plug electrodes 13 and 14 of the spark plug 11.

In detail, the igniter 106 is switched to ON state before the ignition timing arrives. Therefore, the flow of the current between the collector and the emitter is permitted, and the current is given to the primary coil 102. That is, current which flows into the ground through the primary coil 102 and the igniter 106 from the battery occurs. Thus, when the ignition timing arrives, the igniter 106 is switched from the ON state to the OFF state. Therefore, the flow of the current between the collector and the emitter is forbidden, and the current to the primary coil 102 is stopped. Thus, the electromagnetic induction accompanying the stop of the electric current induces in the secondary coil 103 high voltage according to a winding ratio of the secondary coil 103 to the primary coil 102.

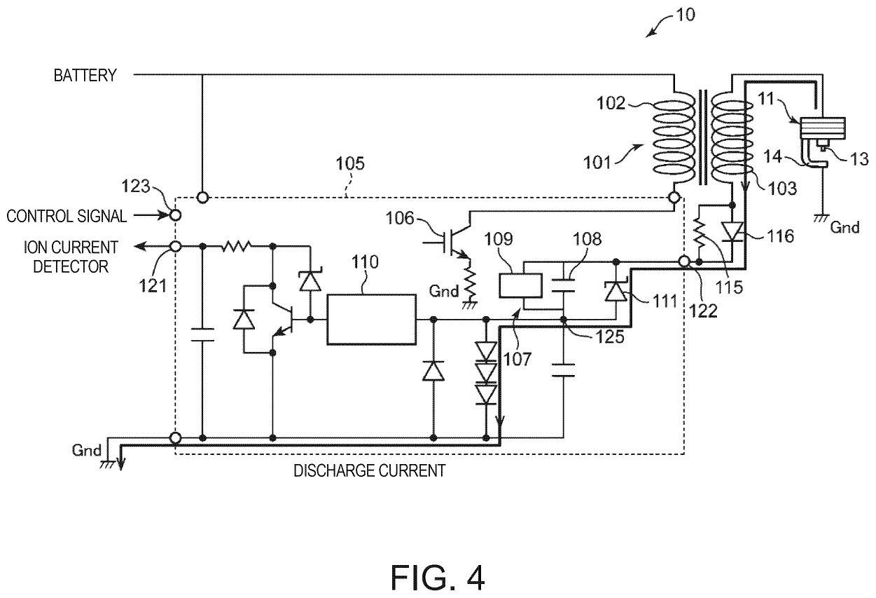

When the high voltage is induced by the secondary coil 103 as described above, electric discharge resulting from the high voltage occurs between the plug electrodes 13 and 14 of the spark plug 11, and sparks are generated. The sparks ignite mixture gas inside the combustion chamber C. FIG. 4 is a view illustrating a flow of the current during the electric discharge (discharge current). As illustrated in this figure, the discharge current flows from the center electrode 13 of the spark plug 11 into the ground via the secondary coil 103, the diode 116, and the Zener diode 111.

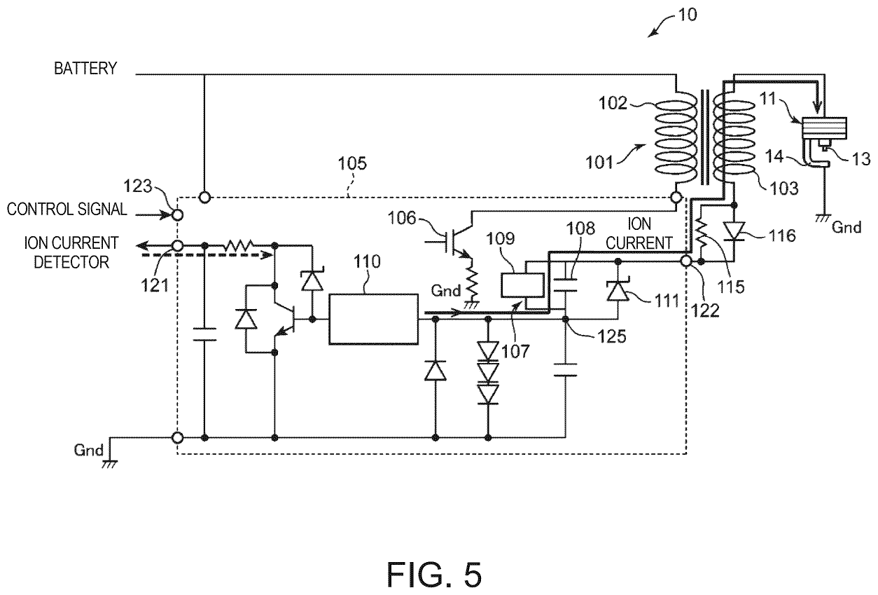

The capacitor device 107 applies to the spark plug 11 bias voltage for detecting the ion current. That is, ion is generated with the reaction of mixture gas inside of the cylinder 2 (i.e., the combustion chamber C). When the bias voltage is applied to the spark plug 11 during the generation of ion, ion current occurs according to the potential difference between the plug electrodes 13 and 14 due to the bias voltage, as illustrated in FIG. 5. The ion current flows toward the center electrode 13 of the spark plug 11 via the current amplifier circuit 110, the capacitor device 107, the resistance 115, and the secondary coil 103. The capacitor device 107 functions as a voltage supply source which applies to the spark plug 11 the bias voltage which leads to the generation of ion current, and is one example of a “bias voltage generator” of the present disclosure.

The capacitor device 107 includes a capacitor 108 and a voltage control circuit 109 which are electrically connected in parallel to each other. The capacitor 108 has a pair of positive and negative polar plates which are chargeable. The voltage control circuit 109 supplies the electric charge to the capacitor 108 for the generation of the bias voltage described above. That is, when the electric charge is supplied from the voltage control circuit 109 and the capacitor 108 is charged, the potential difference occurs between the polar plates of the capacitor 108, the potential difference produces the potential difference also between the plug electrodes 13 and 14 of the spark plug 11, and it functions as the bias voltage. An amount of charge of the capacitor 108 (in other words, the bias voltage) is fluctuated according to an amount of electric charge supplied from the voltage control circuit 109. In other words, the voltage control circuit 109 can control the bias voltage through the amount of electric charge supplied to the capacitor 108.

The current amplifier circuit 110 is a circuit which amplifies the ion current. The current amplified by the current amplifier circuit 110 is detected by the ion current detector 44.

The coil driver 105 has a terminal 123 which accepts a control signal from the ignition controller 41 of the ECU 40. The igniter 106 and the capacitor device 107 (which includes the voltage control circuit 109) operate in response to a control signal inputted through the terminal 123. That is, the ignition controller 41 controls ON/OFF of the electric current to the primary coil 102 through the ON/OFF control of the igniter 106, and controls the bias voltage of the spark plug 11 through the adjustment of the amount of charge of the capacitor device 107 (capacitor 108).

### (3) Determination of Ignition Timing Based On Ion Current

Here, in the spark-ignition engine like this embodiment, there are needs to ignite mixture gas at a timing when thermal efficiency is as high as possible. However, depending on the property of fuel injected into the cylinder 2 (combustion chamber C), knocking, which is an abnormal combustion in which end gas (unburnt gas) carries out self-ignition in the middle of the combustion of mixture gas, may occur, if the ignition timing is not retarded from the timing at which the thermal efficiency is the highest. For example, gasoline fuel used for spark-ignition engines mainly contains isooctane which is a component with high antiknocking capability. However, as the ratio of isooctane changes, knocking may occur if the mixture gas is ignited at the normal ignition timing. Regarding this, a lower limit of the octane number which is an index indicative of the antiknocking capability is often determined for vehicle-mount engines which appear in the market. However, the octane number may not be in agreement with the actual isooctane ratio (volume ratio). Thus, knocking may occur depending on the actual isooctane ratio.

Further, in recent years, from the viewpoint of carbon neutral, bio-fuel (e.g., bioethanol) manufactured from biomass, and synthetic fuel (e.g., e-gasoline manufactured by synthesizing CO₂ and H₂ which is derived from reproducible energy), attracts the attention. These bio-fuel and synthetic fuel are expected to be used as a mixture of the existing gasoline and additives especially during a spreading period. When the use of such various fuels is considered, the ratio of isooctane may greatly fluctuate depending on the fuel used.

Thus, it is considered that in the spark-ignition engines the ratio of isooctane in the fuel used fluctuates at present and in future. Especially when the use of bio-fuel and synthetic fuel is considered, the ratio of isooctane may fluctuate greatly. In order to improve thermal efficiency, while permitting the use of the fuels with different properties, it is desired to ignite the mixture gas at a timing when thermal efficiency is as high as possible, while suppressing knocking by adjusting the ignition timing based on the fuel properties.

Thus, the present inventors arrived at the idea of determining the ignition timing after estimating the ratio of isooctane contained in the fuel (hereinafter, also referred to as “the isooctane ratio”) based on the ion current, paying attention to the correlation between the isooctane ratio and the ion current. That is, this is an idea of detecting the ion current before the spark plug 11 performing the ignition, calculating the isooctane ratio based on the detected ion current (eventually, calculating a given feature quantity (the maximum charge amount qmax which will be described later) indicative of the risk of knocking), and determining the ignition timing at the present cycle based on the calculated feature quantity. Below, this will be described in more detail.

(Correlation between Ion Current and Isooctane Ratio)

Since the ion current originates in ions which is created by ionization of mixture gas containing evaporated and atomized fuel, it is expected that the difference in fuel properties appears as a difference in the ion current. Thus, as a verification experiment based on this expectation, an electric discharge simulation was performed to examine the correlation between the ion current and the isooctane ratio in fuel. That is, under various conditions with different isooctane ratios, virtual electric discharge was performed between the plug electrodes 13 and 14 using a model of the behavior of charged particles (ion or electron) between the plug electrodes 13 and 14, and the ion current which is created during the period up to the electric discharge was investigated. Here, as a value relevant to the ion current, a charge amount q which is a space charge between the plug electrodes 13 and 14 was identified, and a change in the charge amount q according to the isooctane ratio was investigated. Note that, as the charge amount q, an absolute value of the electronic space charge (negative) was used.

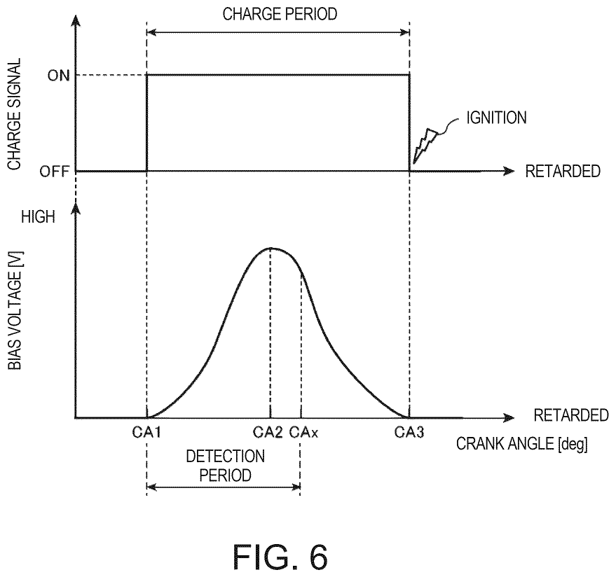

FIG. 6 is a graph illustrating a change according to the crank angle in bias voltage applied to the plug electrodes 13 and 14 to produce the ion current. In this graph, the change in the bias voltage is illustrated together with a charge signal which is an electric current signal to the primary coil 102. Further, a first crank angle CA1 and a third crank angle CA3 in the horizontal axis of the graph are crank angles when starting and stopping the supply (charge) of the electric current to the primary coil 102, respectively. That is, a period from the first crank angle CA1 to the third crank angle CA3 is a charge period during which current is supplied to the primary coil 102. As described above, since the stop of power supply (charge) to the primary coil 102 supplies the electric discharge between the plug electrodes 13 and 14, the end time of the charge period, which is at the third crank angle CA3, is equivalent to the timing when the electric discharge is performed (i.e., equivalent to the ignition timing).

As illustrated in FIG. 6, in this verification experiment, the bias voltage was applied during a period from the start of the charge period to the end of the charge period. That is, the bias voltage was applied at the first crank angle CA1 at which the charge period begins, and the application of the bias voltage was stopped at the third crank angle CA3 at which the charge period ends. Further, in this verification experiment, the bias voltage was changed in a bell-shaped curve. That is, the bias voltage was increased gradually from the first crank angle CA1 to the second crank angle CA2 which is between the first crank angle CA1 and the third crank angle CA3, and the bias voltage was decreased gradually from the second crank angle CA2 to the third crank angle CA3. In other words, in this verification experiment, the bias voltage was applied so that the voltage changes along a bell-shaped curve having a peak near the center of the charge period.

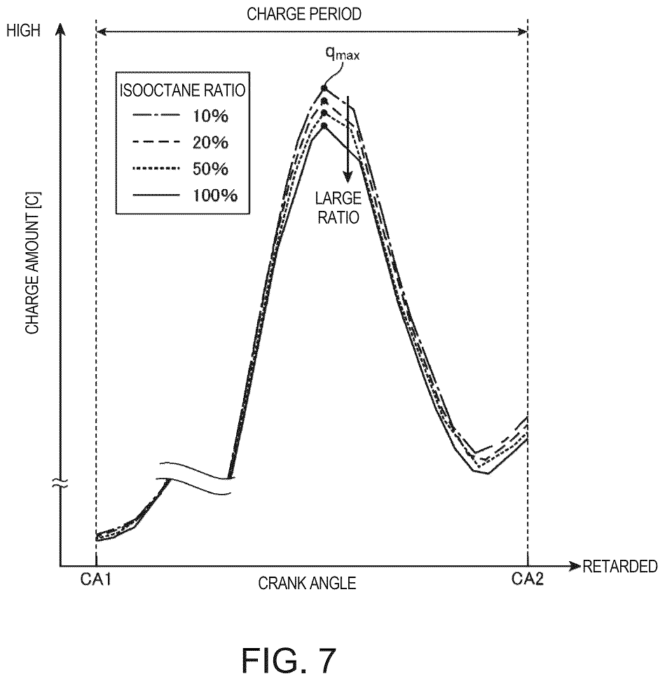

Next, the change in the charge amount q which is caused when the bias voltage is applied was examined as described above, and results were obtained as illustrated in FIG. 7. In detail, under the various conditions with the different isooctane ratios in fuel, the bias voltage which changes in the bell-shaped curve was applied to the spark plug 11 as illustrated in FIG. 6, and the change in the charge amount q at that time was investigated. Between the graphs in FIG. 7, conditions other than the isooctane ratio (for example, engine load and engine speed) are the same.

As illustrated in FIG. 7, the charge amount q changes in accordance with the bell-shaped curve having a peak in the middle of the charge period, similarly to the bias voltage. Further, the maximum charge amount qmax which is a value of the peak (i.e., the maximum value of the charge amount q) changes according to the isooctane ratio. That is, as being clear from FIG. 7, the maximum charge amount qmax decreases as the isooctane ratio increases.

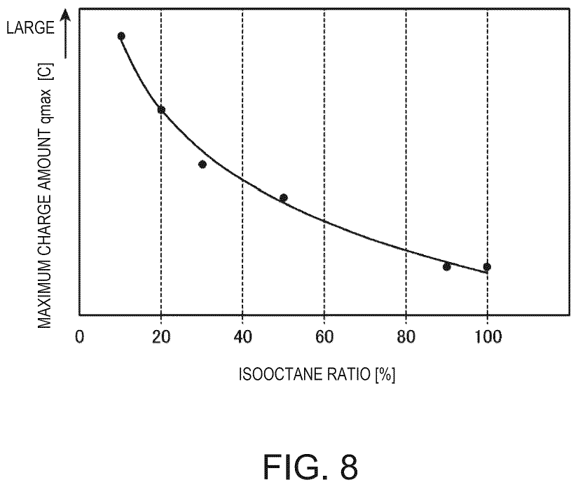

FIG. 8 is a graph directly illustrating a relationship between the isooctane ratio and the maximum charge amount qmax which are obtained from the results of FIG. 7. As is understood also from this graph, the maximum charge amount qmax decreases as the isooctane ratio increases, and increases as the isooctane ratio decreases. Here, the large isooctane ratio means that knocking cannot easily occur, and the small isooctane ratio means that knocking can easily occur. This suggests that the ignition timing in consideration of knocking can be determined based on the maximum charge amount qmax.

### (4) Actual Control

Next, details of an engine combustion control executed based on the knowledge described above are described. As illustrated below, in this embodiment, a standard ignition timing Igr which is determined based on an engine operating state is corrected according to the isooctane ratio estimated from the maximum charge amount qmax which is the feature quantity of the ion current, and mixture gas is ignited at the corrected ignition timing. In addition, since calculation for such an ignition timing determination is performed while supplying the electric current to the primary coil 102 (during the charge period), it is possible to correct the ignition timing within the same cycle as that when this calculation is performed. Below, this will be described in more detail.

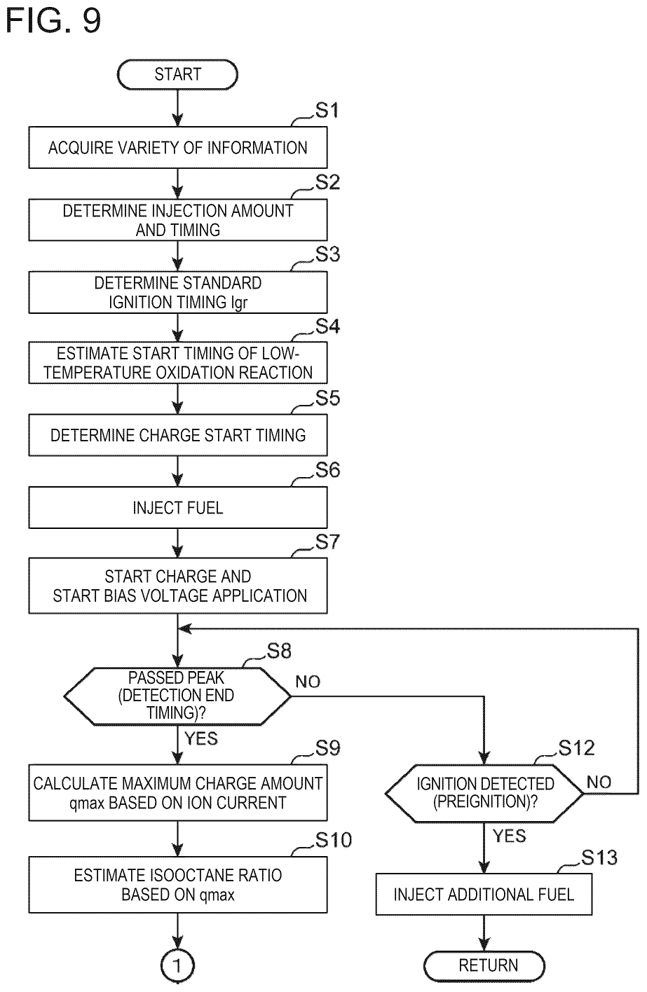

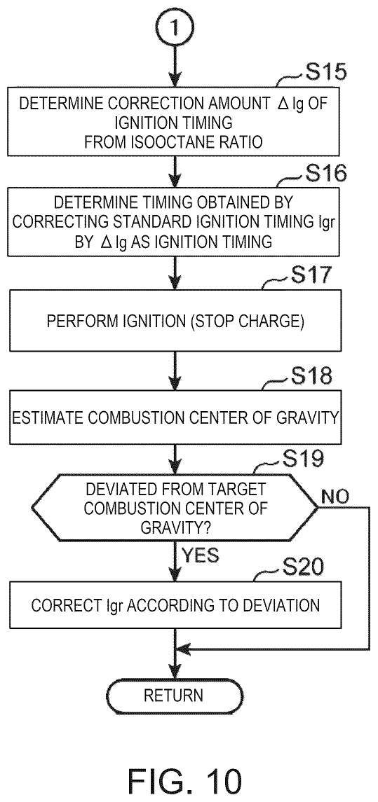

FIGS. 9 and 10 are flowcharts illustrating the details of the combustion control executed by the ECU 40 while the engine operates. When this combustion control starts, the estimator 43 of the ECU 40 acquires variety of information on the engine (Step S1). In detail, the estimator 43 acquires information on the crank angle, the engine speed, the intake air flow rate, the vehicle speed, and the accelerator opening from the detection values of the crank angle sensor SN1, the air flow sensor SN2, the vehicle speed sensor SN3, and the accelerator sensor SN4. Further, based on the accelerator opening and vehicle speed which are acquired, the ECU 40 identifies the engine load (demand torque).

Subsequently, the estimator 43 determines the injection amount and the injection timing of fuel (Step S2). That is, the estimator 43 determines the injection amount which is an amount of fuel to be injected from the injector 15 based on the intake air flow rate and the engine load which are acquired at Step S1. The estimator 43 determines the injection timing which is a timing at which the injection of fuel from the injector 15 is to be started based on the determined injection amount and the engine speed acquired at Step S1.

Subsequently, the estimator 43 determines the standard ignition timing Igr based on the operating condition including the engine load and the engine speed which are acquired at Step S1 (Step S3). The standard ignition timing Igr is defined in advance based on prior experiments for every engine operating condition as an ignition timing at which the thermal efficiency is maximized within a range in which knocking does not occur. Further, the standard ignition timing Igr is defined on the assumption that the isooctane ratio of fuel is a given reference value. Although the reference value of the isooctane ratio may be set suitably, it may be within a range of 90 to 100%, for example, taking the current commercially-available regular gasoline or high-octane gasoline into consideration.

The memory 45B of the ECU 40 stores in advance map data which defines a relationship between the standard ignition timing Igr and the engine operating condition (load, engine speed, etc.) to derive the standard ignition timing Igr based on the engine operating condition. The estimator 43 determines the standard ignition timing Igr from the engine operating condition by referring to the stored map data. Note that the data stored in the memory 45B to derive the standard ignition timing Igr may be an arithmetic expression, without being limited to the map data.

Subsequently, the estimator 43 estimates a start timing of the low-temperature oxidation reaction which is caused with compression of mixture gas (Step S4). The low-temperature oxidation reaction is slow oxidation reaction which occurs before a high-temperature oxidation reaction (substantial combustion reaction) which generates high thermal energy accompanied by flame, and it occurs in the second half of compression stroke when the combustion chamber C reaches a high temperature. The start timing of the low-temperature oxidation reaction may be estimated from the engine operating condition based on prior experiments etc.

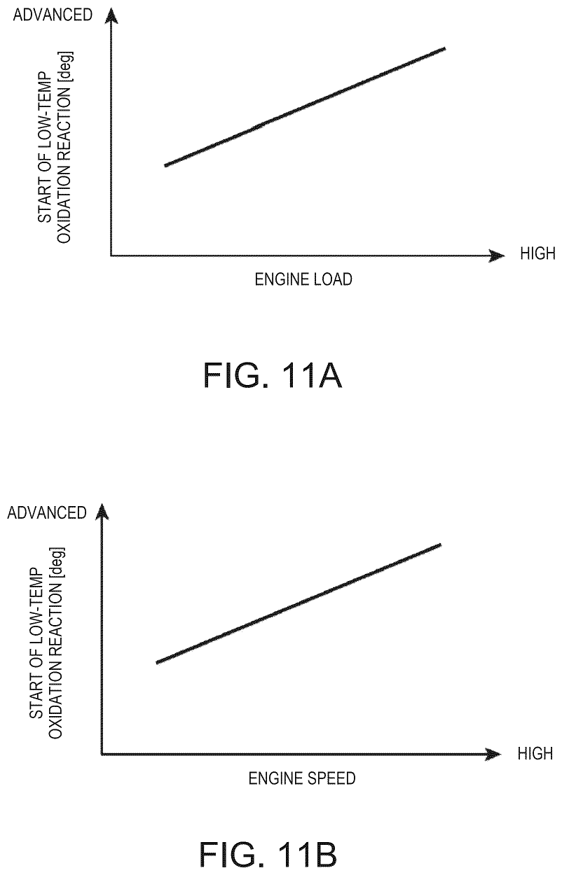

FIG. 11A is a graph illustrating a relationship between the engine load and the start timing of the low-temperature oxidation reaction, and FIG. 11B is a graph illustrating a relationship between the engine speed and the start timing of the low-temperature oxidation reaction. Conditions other than the parameter of the horizontal axis (engine load or engine speed) are the same in these graphs. As illustrated in FIG. 11A, the low-temperature oxidation reaction is started at a timing on the advancing side as the engine load increases. Further, as illustrated in FIG. 11B, the low-temperature oxidation reaction is started at a timing on the advancing side as the engine speed increases. The memory 45B stores in advance the map data or the arithmetic expression corresponding to FIGS. 11A and 11B. The estimator 43 estimates the start timing of the low-temperature oxidation reaction from the engine operating condition (load, engine speed, etc.) using the stored map data or arithmetic expression.

Subsequently, the estimator 43 determines a charge start timing which is a timing to start the supply of the electric current to the primary coil 102 of the ignition circuit 10 (i.e., to start the charge) (Step S5). In this embodiment, the charge start timing is set to be substantially at the same timing as the start of the low-temperature oxidation reaction. The estimator 43 determines the charge start timing based on the start timing of the low-temperature oxidation reaction estimated at Step S4 so that the charge is started at such a timing.

Subsequently, the injection controller 42 of the ECU 40 makes the injector 15 inject fuel at a timing when the injection timing determined at Step S2 arrives (Step S6). The fuel injection is continued until an amount of fuel corresponding to the injection amount determined at Step S2 is injected.

Subsequently, the ignition controller 41 of the ECU 40 starts applying the bias voltage to the spark plug 11, while starting the supply of the electric current to the primary coil 102 (i.e., starting the charge), at a timing when the charge start timing determined at Step S5 arrives (Step S7). That is, the ignition controller 41 controls the igniter 106 so that the supply of the electric current to the primary coil 102 is started at a timing when the charge start timing which occurs substantially at the same timing as the low-temperature oxidation reaction, and controls the capacitor device 107 (voltage control circuit 109) so that the bias voltage is applied to the plug electrodes 13 and 14 of the spark plug 11 at the same timing. Thus, in this embodiment, the supply of the electric current to the primary coil 102 and the application of the bias voltage are started at the same timing which coincides with the start of the low-temperature oxidation reaction. The bias voltage is applied at the same timing as the start of the low-temperature oxidation reaction, because of the necessity of knowing an increase tendency of ion in the cylinder 2 which increases with the start of the low-temperature oxidation reaction.

Here, the start timing of the low-temperature oxidation reaction is on the advancing side as the engine load or the engine speed increases, as illustrated in FIGS. 11A and 11B. From this, the timing when the application of the bias voltage is started at Step S7 is set on the more advancing side as the engine load or the engine speed increases.

Further, at Step S7, similarly to the verification experiment described above, the bias voltage is applied so that the voltage changes in the bell-shaped curve (see FIG. 6). That is, in this embodiment, the ignition controller 41 applies the bias voltage so that the voltage decreases gradually after it increased gradually from the start to the end of the charge. In more detail, the ignition controller 41 starts the application of the bias voltage at the first crank angle CA1 corresponding to the charge start timing determined at Step S5, and increases the bias voltage gradually from this timing. Further, the ignition controller 41 adjusts the bias voltage so that the voltage reaches the peak at the second crank angle CA2 which is near the center of the charge period, and the voltage gradually decreases toward the third crank angle CA3 at which the charge period ends. Note that, although the charge end timing corresponding to the third crank angle CA3 (in other words, the ignition timing) may be changed (corrected) from the standard ignition timing Igr determined at Step S3 by processing of each step described later, the bias voltage is adjusted here under the assumption that the standard ignition timing Igr is the charge end timing.

Subsequently, the estimator 43 determines whether a detection end timing CAx, which is slightly later than the peak period of the bias voltage (second crank angle CA2), has arrived (Step S8). The detection end timing CAx is a timing at which the data of ion current necessary for calculating the maximum charge amount qmax at the following Step S9 is expected to be all gathered, and it is set as a timing retarded by a given small crank angle from the second crank angle CA2 at which the bias voltage reaches a peak. In other words, the period from the first crank angle CA1 at which the application of the bias voltage is started to the detection end timing CAx is a detection period of the ion current necessary for calculating the maximum charge amount qmax.

If it is determined to be NO at Step S8 and it is confirmed that the detection end timing CAx has not yet arrived, the estimator 43 then determines whether ignition of the mixture gas is detected based on the ion current detected by the ion current detector 44 of the ECU 40 (Step S12). If the mixture gas is ignited in this stage, it means that abnormal combustion in which mixture gas carries out a self-ignition before the ignition by the spark plug 11 (i.e., preignition) has occurred. An occurrence of a preignition (i.e., the self-ignition of the mixture gas during the charge period) appears as a phenomenon in which the ion current goes up at an abnormal increasing rate. At Step S12, if the abnormal increase of the ion current is confirmed, the estimator 43 determines that the preignition has occurred. Note that the estimator 43 which determines the occurrence of the preignition corresponds to an “abnormal combustion determinator” in the present disclosure.

If it is determined to be YES at Step S12 and the occurrence of the preignition is confirmed, the injection controller 42 makes the injector 15 inject additional fuel (Step S13). That is, the injection controller 42 makes the injector 15 inject a small amount of additional fuel once finished with the injection of the predefined amount of fuel at Step S6. The injected additional fuel plays a role of causing a temperature drop by latent heat of vaporization to slow down the progress of combustion.

On the other hand, if it is determined to be NO at Step S12 and it is confirmed that the preignition has not yet occurred, the estimator 43 returns to Step S8, where it waits until the detection end timing CAx arrives.

If it is determined to be YES at Step S8 and it is confirmed that the detection end timing CAx has arrived, the estimator 43 calculates the maximum charge amount qmax which is the maximum value of the charge amount q between the plug electrodes 13 and 14 based on the ion current detected by the ion current detector 44 so far (Step S9). Concretely, the estimator 43 calculates the maximum charge amount qmax using the given arithmetic expression based on the data of the ion current detected by the ion current detector 44 during the detection period (FIG. 6) from the first crank angle CA1 which is the application start timing of the bias voltage to the detection end timing CAx, and the data of the bias voltage during the same period. The maximum charge amount qmax calculated in this way can be considered as one of the values which characterize the ion current during the detection period (i.e., the ion current feature quantity).

Here, as described above, the detection end timing CAx is a timing which is somewhat retarded from the second crank angle CA2 (FIG. 6) at which the bias voltage reaches a peak. On the other hand, as understood from FIGS. 6 and 7, the charge amount q between the plug electrodes 13 and 14 (space charge) changes in accordance with the bell-shaped curve substantially similar to the tendency of the bias voltage. Therefore, at the timing of Step S9 which is immediately after the detection end timing CAx, it should have already passed the timing at which the charge amount q between the plug electrodes 13 and 14 reaches the maximum. That is, in this embodiment, the detection end timing CAx is set at the timing which is slightly later than a timing at which the charge amount q is estimated to be the maximum. Thus, even at the timing of Step S9 which is in the middle of the application of the bias voltage, the maximum charge amount qmax which is the maximum value of the charge amount q can be calculated.

Subsequently, the estimator 43 estimates the isooctane ratio of fuel based on the maximum charge amount qmax calculated at Step S9 (Step S10). As described above, the isooctane ratio is the ratio of isooctane contained in the fuel injected into the cylinder 2, and is defined with the tendency as illustrated in FIG. 8 based on the relationship with the maximum charge amount qmax. That is, the isooctane ratio decreases as the maximum charge amount qmax increases. The memory 45B stores in advance the map data or the arithmetic expression corresponding to FIG. 8 for every operating condition including the engine load and the engine speed. The estimator 43 estimates the isooctane ratio from the maximum charge amount qmax using the map data or the arithmetic expression which suits the present operating condition.

Subsequently, the estimator 43 determines a correction amount ΔIg of the standard ignition timing Igr from the isooctane ratio estimated at Step S10 (Step S15). The correction amount ΔIg is set according to a deviating amount of the estimate value of the isooctane ratio obtained at Step S10 from a reference value which is a hypothetical isooctane ratio for setting the standard ignition timing Igr. In detail, the correction amount ΔIg is set larger as the deviating amount of the estimate value from the reference value increases.

Further, the correcting direction by the correction amount ΔIg changes according to a magnitude relationship between the estimate value and the reference value of the isooctane ratio. For example, if the estimate value of the isooctane ratio is smaller than the reference value, the fuel in which knocking occurs more easily than expected is used. Therefore, the correction amount ΔIg in this case serves as a retard correction amount for correcting the standard ignition timing Igr toward the retarding side. On the other hand, if the estimate value of the isooctane ratio is larger than the reference value, the fuel with high antiknocking capability is used. Therefore, the correction amount ΔIg in this case serves as an advancing correction amount for correcting the standard ignition timing Igr toward the advancing side. Note that, if the reference value of the isooctane ratio is a value near 100%, fundamentally all the correction amounts ΔIg become the retard correction amount.

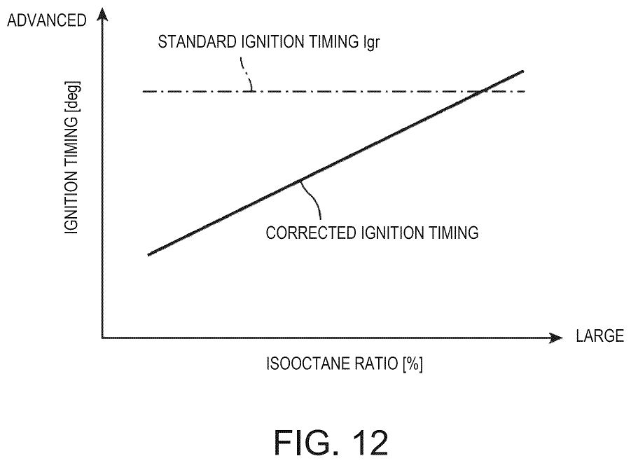

Subsequently, the ignition controller 41 determines the timing which is obtained by correcting the standard ignition timing Igr by the ΔIg determined at Step S15 as the ignition timing by the spark plug 11 (Step S16). The ignition timing determined in this way is set with the tendency as illustrated in FIG. 12 according to the setting method of the correction amount ΔIg described above. As illustrated in FIG. 12, the ignition timing Igr determined at Step S16 (i.e., the corrected ignition timing obtained by correcting the standard ignition timing Igr by ΔIg) is set on the retarding side as the isooctane ratio decreases, and it is set on the advancing side as the isooctane ratio increases.

Subsequently, the ignition controller 41 makes the spark plug 11 perform ignition when the ignition timing determined at Step S16 (i.e., the timing obtained by correcting the standard ignition timing Igr by ΔIg) arrives (Step S17). That is, the ignition controller 41 controls the igniter 106 so that the supply (charge) of the electric current to the primary coil 102 is stopped as the ignition timing arrives. Therefore, the high voltage is induced in the secondary coil 103, and the electric discharge is performed between the plug electrodes 13 and 14 of the spark plug 11 in response to the induced high voltage.

Subsequently, the estimator 43 estimates a combustion center of gravity of the combustion caused by the ignition at Step S17 (Step S18). The combustion center of gravity is a timing when 50% by mass of the injected fuel is burnt. Such a combustion center of gravity may be estimated, for example, through calculation of an amount of heat release accompanying the combustion. The method of calculating the amount of heat release is not limited in particular. However, for example, if the engine is provided with an in-cylinder pressure sensor for detecting an in-cylinder pressure which is a pressure of the combustion chamber C, the amount of heat release may be calculated from a detection value of the in-cylinder pressure sensor, and the combustion center of gravity may be estimated from a change in the calculated amount of heat release.

Subsequently, the estimator 43 determines whether the combustion center of gravity estimated at Step S18 is deviated from a target combustion center of gravity (Step S19). The target combustion center of gravity is defined in advance for every operating condition including the engine load and the engine speed, and is stored in the memory 45B. The estimator 43 compares the combustion center of gravity estimated at Step S18 with the stored target combustion center of gravity, and determines whether there is a deviation therebetween.

If it is determined to be YES at Step S19 and it is confirmed that there is a deviation of the combustion center of gravity, the ignition controller 41 corrects the standard ignition timing Igr according to the deviation (Step S20). For example, if the estimated combustion center of gravity is deviated toward the retarding side from the target combustion center of gravity, the ignition controller 41 corrects the standard ignition timing Igr toward the advancing side. On the contrary, if the estimated combustion center of gravity is deviated on the advancing side from the target combustion center of gravity, the ignition controller 41 corrects the standard ignition timing Igr toward the retarding side.

On the other hand, if it is determined to be NO at Step S19 and it is confirmed that there is no deviation of the combustion center of gravity, the ignition controller 41 does not correct the standard ignition timing Igr, and returns the processing back to Step S1.

### (5) Operation and Effects

As described above, in this embodiment, the bias voltage is applied to the plug electrodes 13 and 14 of the spark plug 11 at the same timing as the start of the low-temperature oxidation reaction, and the ratio of isooctane contained in fuel (that is, the isooctane ratio) is estimated based on the ion current detected during the detection period from the timing at which the application of the bias voltage is started (CA1) to the detection end timing CAx before the ignition timing (CA3). Then, the ignition timing in the same cycle as that when the estimation is performed is corrected according to the isooctane ratio, and ignition by the spark plug 11 is performed at the corrected ignition timing. According to such a configuration, there is an advantage that the occurrence of knocking can be prevented in advance, while improving the thermal efficiency.

That is, in this embodiment, since the isooctane ratio of fuel can be estimated based on the ion current detected before the ignition timing, and the ignition timing is corrected according to the estimated isooctane ratio, the ignition timing can be adjusted to the suitable timing in consideration of the difference in the isooctane ratio. In detail, the isooctane ratio is one of the typical fuel properties which influence on the risk of knocking. Therefore, according to this embodiment in which the ignition timing is corrected based on the isooctane ratio, the ignition timing can be set on the advancing side as the isooctane ratio increases, and the mixture gas can be ignited at the ignition timing at which the thermal efficiency is as high as possible, within the range where knocking does not occur. In addition, since the isooctane ratio is estimated before the ignition timing, the ignition timing in the same cycle as that when the estimation is performed can be adjusted in advance to the suitable timing in consideration of knocking. Therefore, the occurrence of knocking can be prevented in advance, while improving the thermal efficiency.

Concretely, in this embodiment, as the ion current feature quantity which correlates with the isooctane ratio, the maximum charge amount qmax which is the maximum value of the charge amount q (space charge) between the plug electrodes 13 and 14 during the detection period is calculated, and the isooctane ratio is estimated to be larger as the calculated maximum charge amount qmax decreases (see FIG. 8). According to such a configuration, the isooctane ratio can be estimated appropriately using the correlation between the maximum charge amount qmax and the isooctane ratio.

In this embodiment, the bias voltage is adjusted so that, during application of the bias voltage, the voltage decreases gradually after it increased gradually (see FIG. 6). Thus, when the bias voltage is changed in the bell-shaped curve, the charge amount q between the plug electrodes 13 and 14 can be changed in a similar bell-shaped curve. This makes it easier to calculate the maximum charge amount qmax which is the maximum value of the charge amount q. Further, since the ion current which increases with the start of the low-temperature oxidation reaction is further amplified by the gradual increase of the bias voltage, sensitivity of the maximum charge amount qmax which changes with the difference of the isooctane ratio can be improved. Therefore, the estimation precision of the isooctane ratio can be improved.

Further, in this embodiment, the capacitor device 107 (FIG. 3) is connected to the secondary coil 103, and the bias voltage is applied to the plug electrodes 13 and 14 by the static charge of the capacitor device 107. According to such a configuration, the bias voltage can be controlled appropriately by adjusting the amount of charge of the capacitor device 107.

In this embodiment, the application start timing of the bias voltage is adjusted so that it is advanced as the engine load or the engine speed increases. According to such a configuration, the bias voltage can be applied at the same timing as the start of the low-temperature oxidation reaction which is advanced as the engine load or the engine speed increases (see FIGS. 11A and 11B), and the ion current which increases with the start of the low-temperature oxidation reaction can be detected appropriately.

In this embodiment, the occurrence of the preignition is determined based on the detected ion current, and the additional fuel is injected if the occurrence of the preignition is determined. According to such a configuration, since the latent heat of vaporization of the additionally-injected fuel lowers an internal temperature of the cylinder 2, the progress of combustion of mixture gas can be slowed down to reduce the influence of the preignition.

### (6) Modifications

Although the desirable embodiment of the present disclosure is described above, the present disclosure is not limited to this embodiment and various modifications thereof are possible without departing from the scope of the present disclosure.

For example, although in this embodiment the maximum charge amount qmax which is the maximum value of the charge amount q (space charge) between the plug electrodes 13 and 14 is calculated as the ion current feature quantity which correlates with the isooctane ratio, the ion current feature quantity is not limited to the maximum charge amount qmax, as long as it is a value which can be calculated from the ion current detected by the ion current detector 44 and correlates with the isooctane ratio. For example, the maximum ion current which is the maximum value of the ion current detected by the ion current detector 44 may be calculated as the ion current feature quantity. Also in this case, the isooctane ratio can be estimated from the calculated maximum ion current. That is, it can be estimated that the isooctane ratio is larger as the maximum ion current decreases.

Although in this embodiment the isooctane ratio of fuel is estimated from the ion current (or the ion current feature quantity) detected during the given detection period, the target to be estimated is not limited to the isooctane ratio, as long as it is a fuel property relevant to the risk of knocking.

Although in this embodiment the supply (charge) of the electric current to the primary coil 102 and the application of the bias voltage to the plug electrodes 13 and 14 are started simultaneously, they may be started at different timings. That is, the bias voltage may be applied to the plug electrodes 13 and 14 at the same timing as the start of the low-temperature oxidation reaction, while the supply of the electric current to the primary coil 102 may be started at a timing somewhat earlier or later than the application start of the bias voltage.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

2 Cylinder
11 Spark Plug
15 Injector
41 Ignition Controller
42 Injection Controller
43 Estimator (Abnormal Combustion Determinator)
44 Ion Current Detector
101 Ignition Coil
102 Primary Coil
103 Secondary Coil
106 Igniter
107 Capacitor Device (Bias Voltage Generator)
qmax Maximum Charge Amount

What is claimed is:

1. A combustion control system to be applied to an engine provided with a cylinder, an injector configured to inject fuel into the cylinder, and a spark plug configured to ignite a mixture gas containing the fuel injected from the injector, the system comprising:
an ignition coil including a primary coil and a secondary coil;
an igniter configured to induce high voltage in the secondary coil through ON/OFF of supply of electric current to the primary coil, and cause electric discharge between plug electrodes of the spark plug by the induced high voltage;
a bias voltage generator configured to apply bias voltage for detecting ion current to the plug electrodes, the ion current occurring between the plug electrodes and originating in ions inside the cylinder; and
a processor configured to execute:
an ion current detector to detect the ion current;
an ignition controller to control the bias voltage generator to apply the bias voltage to the plug electrodes at a same timing as a start of a low-temperature oxidation reaction caused inside the cylinder with compression of the mixture gas, and control the igniter to cause the electric discharge between the plug electrodes at an ignition timing set to a timing later than the start of the low-temperature oxidation reaction; and
an estimator to estimate a property of the fuel injected from the injector based on the ion current detected by the ion current detector during a detection period from a timing at which the application of the bias voltage is started to a given timing earlier than the ignition timing,
wherein the ignition controller corrects the ignition timing according to the property of the fuel, in a same cycle as that when the property of the fuel is estimated, and controls the igniter to perform the electric discharge at the corrected ignition timing.

2. The combustion control system of claim 1,
wherein the estimator estimates a ratio of isooctane contained in the fuel as the property of the fuel, and
wherein the ignition controller corrects the ignition timing toward a retarding side as the ratio of isooctane decreases.

3. The combustion control system of claim 2, wherein the estimator calculates an ion current feature quantity correlating with the property of the fuel, based on the ion current detected during the detection period, and estimates the ratio of isooctane from the calculated ion current feature quantity.

4. The combustion control system of claim 3,
wherein the ion current feature quantity is a maximum charge amount that is a maximum value of a charge amount between the plug electrodes during the detection period, and
the estimator estimates the ratio of isooctane to be larger as the maximum charge amount decreases.

5. The combustion control system of claim 3,
wherein the ion current feature quantity is a maximum ion current that is a maximum value of the ion current during the detection period, and
wherein the estimator estimates the ratio of isooctane to be larger as the maximum ion current decreases.

6. The combustion control system of claim 4, wherein the ignition controller controls the bias voltage generator so that the bias voltage increases gradually from the start of the low-temperature oxidation reaction and decreases gradually thereafter.

7. The combustion control system of claim 5, wherein the ignition controller controls the bias voltage generator so that the bias voltage increases gradually from the start of the low-temperature oxidation reaction and decreases gradually thereafter.

8. The combustion control system of claim 1, wherein the bias voltage generator is a capacitor device connected to the secondary coil.

9. The combustion control system of claim 1, wherein the ignition controller controls the bias voltage generator so that the application start of the bias voltage is advanced as an engine speed increases.

10. The combustion control system of claim 2, wherein the ignition controller controls the bias voltage generator so that the application start of the bias voltage is advanced as an engine speed increases.

11. The combustion control system of claim 3, wherein the ignition controller controls the bias voltage generator so that the application start of the bias voltage is advanced as an engine speed increases.

12. The combustion control system of claim 4, wherein the ignition controller controls the bias voltage generator so that the application start of the bias voltage is advanced as an engine speed increases.

13. The combustion control system of claim 5, wherein the ignition controller controls the bias voltage generator so that the application start of the bias voltage is advanced as an engine speed increases.

14. The combustion control system of claim 1, wherein the ignition controller controls the bias voltage generator so that the application start of the bias voltage is advanced as an engine load increases.

15. The combustion control system of claim 2, wherein the ignition controller controls the bias voltage generator so that the application start of the bias voltage is advanced as an engine load increases.

16. The combustion control system of claim 3, wherein the ignition controller controls the bias voltage generator so that the application start of the bias voltage is advanced as an engine load increases.

17. The combustion control system of claim 4, wherein the ignition controller controls the bias voltage generator so that the application start of the bias voltage is advanced as an engine load increases.

18. The combustion control system of claim 5, wherein the ignition controller controls the bias voltage generator so that the application start of the bias voltage is advanced as an engine load increases.

19. The combustion control system of claim 1, wherein
the estimator is further configured to determine an occurrence of a preignition based on the ion current detected by the ion current detector, and
the processor is further configured to execute an injection controller configured to cause the injector to inject additional fuel when the occurrence of the preignition is determined.
